(19) United States
(12) Patent Application Publication
(10) Pub. No.: US 2021/0027777 A1
(43) Pub. Date: Jan. 28, 2021

(54) METHOD FOR MONITORING PHONATION AND SYSTEM THEREOF

(71) Applicants: Far Eastern Memorial Hospital, New Taipei City (TW); National Yang-Ming University, Taipei City (TW)

(72) Inventors: CHI-TE WANG, New Taipei City (TW); YING-HUI LAI, Taipei City (TW)

(21) Appl. No.: 16/937,615

(22) Filed: Jul. 24, 2020

Related U.S. Application Data
(60) Provisional application No. 62/878,749, filed on Jul. 26, 2019.

(51) Int. Cl. G10L 15/22; G10L 15/06; G10L 15/02; G10L 15/16; G06K 9/62; G06N 3/04

(52) U.S. Cl. CPC G10L 15/22; G10L 15/063; G10L 15/02; G06N 3/0454; G06K 9/6269; G06K 9/6276; G10L 15/16

(57) ABSTRACT

The invention provides a method to generate a personalized phonation monitoring module, and a system thereof. The method comprises collecting, by a recorder, a voice from an individual; converting, by a processor, the voice to a voice signal; extracting a signal feature from the voice signal; providing a trained individualized speech recognition neural network; generating, by applying the signal feature to the trained speech recognition neural network, a voice marker; and generating a personal phonation recognition module including the voice marker. The invention is capable of providing real-time, delayed, or summary feedback of phonation when the analysis result is higher or lower than the pre-set value.

### CROSS REFERENCE TO RELATED APPLICATION

The present application claims priority to U.S. Provisional Application Ser. No. 62/878,749, filed on Jul. 26, 2019, which is hereby incorporated by reference in their entirety.

### FIELD

This invention relates to a method and system for monitor phonation, and more particularly, to a method and system for monitor phonation that employee wireless voice recorder.

### BACKGROUND

Voice disorder is a common-seen medical burden in modern society, which can substantially reduce an individual's quality of life. Common etiologies for voice disorder include phonation habit misuse (e.g., shouting, screaming), overuse, higher background noise, and occupational vocal demand. Although voice therapy and surgery mostly provide good treatment effectiveness, recurrences after treatment are quite common if patients cannot adjust their phonation habits. Accordingly, another critical component for successful management of voice disorders is to help patients control phonation amount (for example, speaking speed and volume) with adequate rests during daily use.

The concept of ambulatory voice monitoring to record the amount and percentage of phonation had been developed for decades. However, limited by available technologies, most studies require an additional device to be wore on the neck (e.g., a contact microphone) to capture voice signals and measure/record the phonation time over a certain period. For example, a previous study applied a contact microphone or accelerometer attached to the anterior neck (Titze, Hunter & Švec, 2007). A later research uses the Pocket PC system to develop a portable device, wiring to a neck mounted contact microphone for voice monitoring and recording (Carroll et al., 2006). Studies using tools refined from this prototype had been published (Mehta, Zanartu, Feng, Cheyne, & Hillman, 2012 and Remade, Morsomme, & Finck, 2014), and they help patients to better control and track vocal hyperfunction. Another available device for ambulatory voice monitoring is designed as a neck collar, also using a contact microphone to analyze voicing signals from neck acceleration (Searl & Dietsch, 2015).

There are several disadvantages existed among the devices. First, wiring and taping of a microphone over the skin of the anterior neck may cause discomforts. Phonation volume measured from the neck accelerometer needs daily calibration for accurate matching with standard measurements from the voice emitted from the mouth. Hence, most of these devices are applied in the settings of academic researches. Meanwhile, wearing a neck collar in a public working environment (e.g., classroom) may cause a labeling effect of the users, which could limit the acceptability of routine daily use. Besides, limited by available technology, only feedback of voice volume can be provided in the above devices (Van Stan, Mehta, Sternad, & Hillman, 2017), whereas the accumulated voice use was mostly recorded over a certain period with post-hoc feedback.

To overcome the limitation of current voice monitoring devices, an improvement of the equipment or method is necessary.

### SUMMARY OF THE DISCLOSURE

The present invention provides a method to generate a phonation monitoring module. The method comprises: collecting, by a recorder, a voice from an individual; converting, by a processor, the voice to a voice signal; extracting a signal feature from the voice signal; providing a trained speech recognition neural network; generating, by applying the signal feature to the trained speech recognition neural network, a voice marker; and generating a personal phonation recognition module including the voice marker.

Preferably, the wherein in the step of extracting a signal feature from the voice signal, the signal feature is extracted by applying Mel frequency cestrum coefficients (MFCCs).

Preferably, the trained speech recognition neural network is provided through a decision tree procedure, a random forest procedure, an Adaboost procedure, a K Nearest-neighbor procedure, a Support Vector Machine (SVM) procedure, a Gaussian Mixture Model (GMM), a Deep Neural Network (DNN) procedure, a convolution neural network (CNN) procedure, a recurrent neural network (RNN) procedure.

Preferably, the personal phonation recognition module is stored on a portable device or a cloud.

The present invention further provides a method for monitoring phonation. The method comprises: recording, by a recorder, a voice from an individual; analyzing, by comparing the voice with the personal phonation recognition module as described in the previous paragraph, to generate an analysis result; and comparing the analysis result with a pre-set value. A feedback signal is given when the analysis result is higher or lower than the pre-set value.

Preferably, the feedback signal comprises a light, a sound, a vibration, a temperature variation, a letter notice, a figure notice and any combination thereof.

Preferably, the recorder is a portable recorder or a wireless headphone.

Preferably, the individual has a disease including phonotraumatic lesions and hyperfunctional voice disorders.

Preferably, the analysis result comprises: a phonation percentage (or phonation ratio, which refers to the amount when the users are speaking over a certain period of time), a sound pressure level (volume) of speech a pitch (fundamental frequency) of voice and a distribution of speech and nonspeech.

The present invention further provides a system to generate a phonation monitoring module. The system comprises: a recorder; a memory to store executable instructions; and a processor. The processor couples to the memory, and facilitates execution of the executable instructions to perform operations, comprising: collecting a voice from an individual; converting the voice to a voice signal; extracting a signal feature from the voice signal; providing a trained speech recognition neural network; generating a voice marker by applying the signal feature to the trained speech recognition neural network; and generating a personal phonation recognition module including the voice marker.

Preferably, the signal feature is extracted by applying Mel frequency cestrum coefficients (MFCCs).

Preferably, the trained speech recognition neural network is provided through a decision tree procedure, a random forest procedure, an Adaboost procedure, a K Nearest-neighbor procedure, a Support Vector Machine (SVM) procedure, a Gaussian Mixture Model (GMM), or a Deep Neural Network (DNN) procedure, a convolution neural network (CNN) procedure, a recurrent neural network (RNN) procedure.

Preferably, the personal phonation recognition module is stored on a portable device, a smart home/speaker device, a hearing assistive device or a cloud.

The present invention further provides a system used to monitor an individual's phonation. The system comprises a recorder and a computing device. The computing device comprises a memory to store executable instructions; and a processor, coupled to the memory, and facilitates execution of the executable instructions to perform operations. The operations comprises: recording a voice from an individual; analyzing, by comparing the voice with the personal phonation recognition module as described in the previous paragraph, the voice; and comparing the analysis result with a pre-set value, wherein a feedback signal is given when the analysis result is higher or lower than the pre-set value. The recorder connects with the computing device.

Preferably, the feedback signal comprises a light, a sound, a vibration, a temperature variation, a letter notice, a figure notice and any combination thereof.

Preferably, the recorder is a portable recorder or a wireless headphone.

Preferably, the individual has a disease including phonotraumatic lesions and hyperfunctional voice disorders.

Preferably, the analysis result comprises: a phonation percentage, a sound pressure level, a phonation ratio, a pitch of voice and a distribution of speech and nonspeech.

### BRIEF DESCRIPTION OF THE DRAWINGS

One or more embodiments are illustrated by way of example, and not by limitation, in the figures of the accompanying drawings, wherein elements are having the same reference numeral designations represent like elements throughout. The drawings are not to scale, unless otherwise disclosed.

FIG. 1 is a flowchart of the method to generate a phonation monitoring module according to an embodiment of the present invention;

FIG. 2 is a flowchart of the method for monitoring phonation;

FIG. 3 illustrates a system to generate a phonation monitoring module;

FIG. 4 illustrates a system used to monitor an individual's phonation according to a first embodiment of the present invention;

FIGS. 5A-5B illustrates a system used to monitor an individual's phonation according to the second embodiment of the present invention;

FIG. 6 illustrates the experimental results of the accuracy rate of the personal phonation recognition module among five teachers;

FIGS. 7A-7B illustrates the analysis results of a first tester, with the analysis results including the distribution of speech vs non-speech, the phonation percentage/ratio (per minute), the sound pressure level, and the fundamental frequency (pitch);

FIGS. 8A-8B illustrates the analysis results of a second tester, with the analysis results including the distribution of speech vs non-speech, the phonation percentage/ratio (per minute), the sound pressure level, and the fundamental frequency (pitch);

FIGS. 9A-9B illustrates the analysis results of a third tester, with the analysis results including the distribution of speech vs non-speech, the phonation percentage/ratio (per minute), the sound pressure level, and the fundamental frequency (pitch);

FIGS. 10A-10B illustrates the analysis results of a fourth tester, with the analysis results including the distribution of speech vs non-speech, the phonation percentage/ratio (per minute), the sound pressure level, and the fundamental frequency (pitch); and

FIGS. 11A-11B illustrates the analysis results of a fifth tester, with the analysis results including the distribution of speech vs non-speech, the phonation percentage/ratio (per minute), the sound pressure level, and the fundamental frequency (pitch).

The drawings are only schematic and are non-limiting. In the drawings, the size of some of the elements may be exaggerated and not drawn on scale for illustrative purposes. The dimensions and the relative dimensions do not necessarily correspond to actual reductions to practice of the invention. Any reference signs in the claims shall not be construed as limiting the scope. Like reference symbols in the various drawings indicate like elements.

### DETAILED DESCRIPTION

Unless defined otherwise, all technical and scientific terms used herein have the same meanings as commonly understood by one of skill in the art to which this disclosure belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

Reference throughout this specification to “one embodiment” or “an embodiment” means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

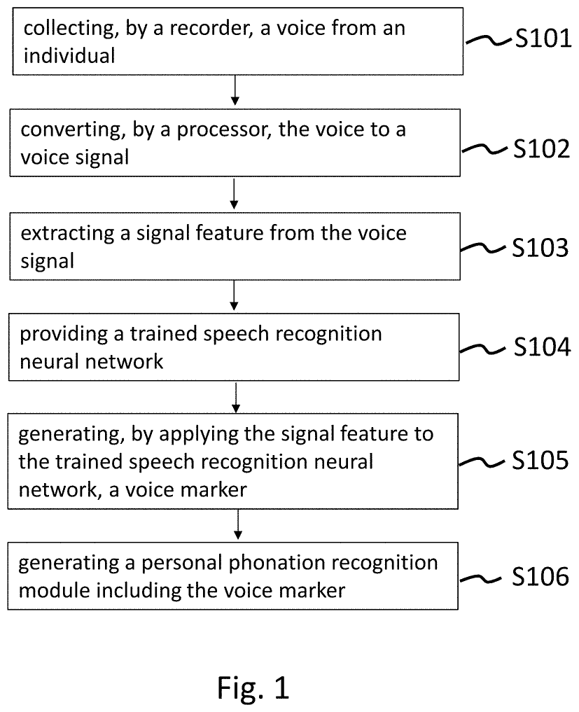

Reference is made to FIG. 1, which illustrates a flowchart of the method to generate a phonation monitoring module according to an embodiment of the present invention. The method to generate a phonation monitoring module includes the following steps. First, in step S101, collecting, by a recorder, a voice from an individual. The recorder may be in any form, which means any device that possesses the function of recording may be applied in the present invention.

Next, in step S102, converting, by a processor, the voice to a voice signal. Next, in step S103, extracting a signal feature from the voice signal. In the present embodiment, the feature extracting is done by applying Mel frequency cestrum coefficients (MFCCs). However, the scope of the present invention should not be limited to MFCCs only, other approaches that may achieve feature extraction can also be applied in the present invention (some other features may also suitable for acoustic analysis, e.g., log-power spectrogram, i-vector, X-vector, fundamental frequency, phonetic posteriorgrams, linear predictive coefficients, linear predictive cepstral coefficients, data-driven approach, etc.).

Next, in step S104, providing a trained speech recognition neural network. Next, in step S105, generating, by applying the signal feature to the trained speech recognition neural network, a voice marker. Finally, in step S106, generating a personal phonation recognition module including the voice marker. This module is design to specifically recognize the user's own voice against other speakers and back ground noise. Preferably, the trained speech recognition neural network may be a trained individualized speech recognition neural network.

The trained speech recognition neural network as described in the previous paragraph is not limited to any particular approach. It may be provided through a decision tree procedure, a random forest procedure, an Adaboost procedure, a K Nearest-neighbor procedure, a Support Vector Machine (SVM) procedure, a Gaussian Mixture Model (GMM), a Deep Neural Network (DNN) procedure, a convolution neural network (CNN) procedure, a recurrent neural network (RNN) procedure. However, in the present invention, the Deep Neural Network (DNN) procedure is applied.

Further, the personal phonation recognition module is stored on a portable device, a smart home/speaker device, a hearing assistive device or a cloud. The smart speaker may be, e.g., a Google Home or an Amazon Echo. In the scenario that the personal phonation recognition module is stored on a portable device, it can be understood that the processing is done on the device end, whereas in the scenario that the personal phonation recognition module is stored on a cloud, it can be understood that the processing is done in a remote cloud (e.g., edge computing). The portable device may be a smart/mobile phone, smart speaker (e.g. Google Home, Amazon Echo . . . ), or a hearing assistive device.

According to the present embodiment of the present invention, it is capable of providing real-time feedback based on individual demand (preferably, the present invention can be guided by an ear, nose, throat doctor or speech pathologist).

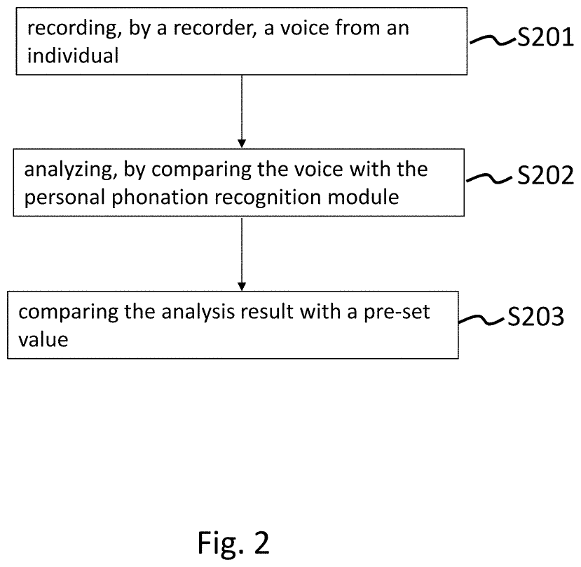

Reference is next made to FIG. 2, which illustrates a flowchart of the method for monitoring phonation. The method for monitoring phonation includes the following steps. First, in step S201, recording, by a recorder, a voice from an individual. The recorder may be implemented in any form, which means any device that possesses the function of recording may be applied in the present invention. In the present embodiment, the recorder is a smartphone. The recorder may be a portable recorder or a wireless headphone, or any form of smart device/speaker (e.g. Amazon Echo, Google Home . . . ), hearing assistive device.

Next, in step S202, analyzing, by comparing the voice with the personal phonation recognition module as described in the previous embodiment, to generate an analysis result. Finally, in step S203, comparing the analysis result with a pre-set value. For example, the upper limit of phonation ratio over a certain period of time, or the upper limit of speaking volume, measured in sound pressure level (SPL). In the present embodiment, further, a feedback signal is given when the analysis result is higher or lower than the pre-set value. This pre-set value is preferably defined by a clinician (e.g. ENT doctor or speech pathologist), based on individual need and medical conditions.

The feedback signal is not limited in any form. The feedback signal may be a light, a sound, a vibration, a temperature variation, a letter notice, a figure notice and any combination thereof. That is, any signal that brings attention may serve as the feedback signal. The feedback signal serves as a function of bringing attention. The feedback may be provided in a real-time basis, delayed (e.g. every fourth event), or a post-hoc summary over a certain period of time.

To the above descriptions that the feedback signal may be given in forms of real-time, delayed, or a combination thereof, it can be construed that the how the feedback signal is given is not limited. The feedback signal may be given according to different practical demands. For example, the feedback may be provided in a real-time basis, which means that every time when the analysis result is higher or lower than the pre-set value then the feedback signal is given out. Another example is that the feedback signal is given out based on accumulated basis, which means that the feedback signal is given out until, e.g., the fourth event has happened.

Further, the analysis result may include, but not limited to, a phonation percentage/ratio, a sound pressure level, a pitch of voice and a distribution of speech and nonspeech.

Mel frequency cepstrum coefficients (MFCCs) is one of the most commonly used feature extraction methods in the field of sound research (Davis & Mermelstein, 1980). The core concept of the MFCCs is the linear transformation of the logarithmic energy spectrum based on the nonlinear mel scale of sound frequency. Past researches have pointed out that the sound features extracted using this MFCC feature are closer to the operation method of human cochlea's perception of sound, and have good effects in multiple sound situation recognition applications (e.g., speech recognition, speaker recognition . . . etc.). MFCC feature extraction includes seven steps, including: (1) Pre-emphasis; (2) Frame blocking; (3) Hamming window; (4) Discrete Fourier transform; (5) Triangular band-pass filter; (6) Discrete cosine transformation; and (7) Difference cepstrum coefficient.

The purpose of pre-emphasis is to eliminate the effects of the vocal cords and lips during the vocalization process, to compensate for the high-frequency part of the voice signal suppressed by the pronunciation system. For Frame blocking, it is for assembling continuous speech signals into N observation units for signal analysis. Hamming window is for reducing discontinuous connection between the front and back of the sound box, and Triangular band-pass filter involves filter design based on the characteristics of the human cochlea. Discrete cosine transformation enhances the uniqueness of each dimension feature, and Difference cepstrum coefficient is for capturing the speed and acceleration information of continuous speech changes.

According to the embodiment of the present invention, it follows the MFCC and DNN architecture for speech recognition, uses a framework of a device (an Accelerate Framework of an iOS device) to provide an optimized mathematical operation library, makes full use of the advantages of the iOS system's higher priority for sound, and implants the two core functions of extracting MFCC features and DNN voice recognition into mobile phones. In other words, when the subject (testers) uses it, the program uses the recorder (e.g., a built-in microphone of an AirPods®) to convert the sound into MFCC features immediately, and uses the built-in DNN model to detect whether each analysis sound frame (64 ms) is the user's voice (some other features may also be suitable for acoustic analysis, e.g., log-power spectrogram, i-vector, X-vector, fundamental frequency, phonetic posteriorgrams, linear predictive coefficients, linear predictive cepstral coefficients, data-driven approach, etc.).

At the same time, eliminating background noises or interferences from other sound sources can achieve the goal of measuring tester's voice behavior such as voice ratio and voice volume. In order to provide feedback for excessive voice use in the future, an adjustable feedback threshold for researchers and users to adjust is also set according to their personal circumstances in the present invention.

According to the present embodiment of the present invention, it is capable of providing real-time feedback based on individual demand (preferably, the present invention can be guided by an ear, nose, throat doctor or speech pathologist).

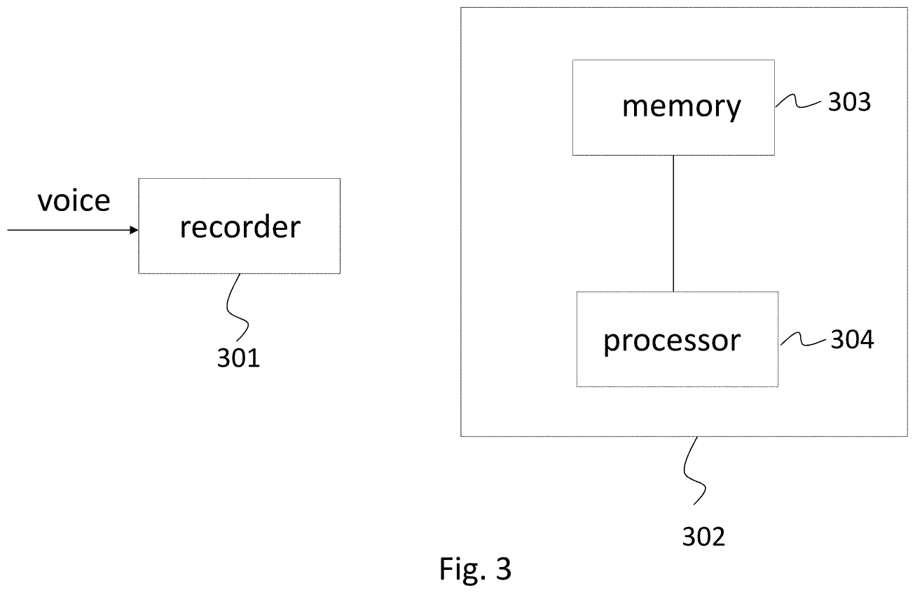

Reference is next made to FIG. 3, which illustrates a system to generate a phonation monitoring module. The system includes a recorder 301, a device 302 including a memory 303, and a processor 304. In the present embodiment, the recorder 301 and the device 303 are connected through wireless communication.

The recorder 301 is configured to receive a voice signal. The memory 303 stores store executable instructions. The processor 304 couples to the memory 303. The processor 304 facilitates execution of the executable instructions to perform operations. The operations comprise the following steps of collecting a voice from an individual, converting the voice to a voice signal, extracting a signal feature from the voice signal, providing a trained speech recognition neural network, generating a voice marker by applying the signal feature to the trained speech recognition neural network and generating a personal phonation recognition module including the voice marker.

In the present embodiment, the signal feature is extracted by, but not limited to, applying Mel frequency cestrum coefficients (MFCCs). Moreover, the trained speech recognition neural network may be provided through a decision tree procedure, a random forest procedure, an Adaboost procedure, a K Nearest-neighbor procedure, a Support Vector Machine (SVM) procedure, a Gaussian Mixture Model (GMM), a Deep Neural Network (DNN) procedure, a convolution neural network (CNN) procedure, a recurrent neural network (RNN) procedure.

The personal phonation recognition module is stored on a portable device, a smart home/speaker device, a hearing assistive device or a cloud. However, where the personal phonation recognition module is stored should not be limited. Person with ordinary skill in the art can adopt different implementations according to different practical demands. The smart speaker may be, e.g., a Google Home or an Amazon Echo.

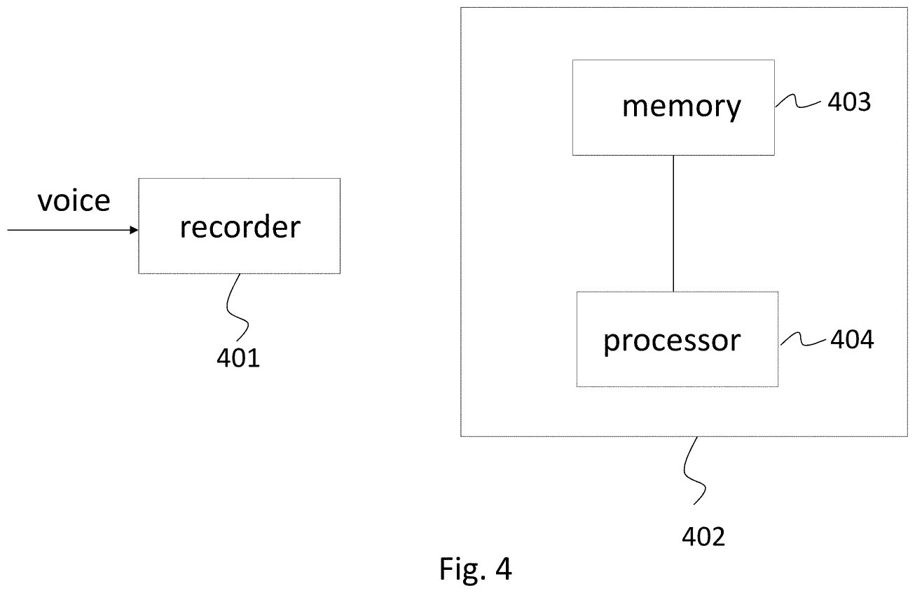

Reference is next made to FIG. 4, which illustrates a system used to monitor an individual's phonation according to a first embodiment of the present invention. As shown in FIG. 4, the system includes a recorder 401 and a computing device 402.

The computing device 402 includes a memory 403 and a processor 404. The memory 403 and processor 404 are electrically connected. The memory 403 is configured to store executable instructions, and the processor 404 is configured to facilitate execution of the executable instructions to perform operations including recording a voice from an individual, analyzing, by comparing the voice with the personal phonation recognition module as provided in the previous paragraph, the voice, and comparing the analysis result with a pre-set value. A feedback signal is given when the analysis result is higher or lower than the pre-set value. Further, the recorder 401 connects with the computing device 402 through wireless communication.

The feedback signal can be implemented in any way, so long as the feedback signal serves the function to bring attention. The feedback signal may be a light, a sound, a vibration, a temperature variation, a letter notice, a figure notice and any combination thereof. The recorder 401, may be a portable recorder or a wireless headphone in the present embodiment.

As described above, the feedback may be provided in a real-time basis, delayed (e.g. every fifth event), or a post-hoc summary over a certain period of time. The post-hoc summary over a certain period of time means that the feedback signal is not given until after a certain period of time.

According to the present invention, it can be utilized to treat diseases including phonotraumatic lesions and hyperfunctional voice disorders. Further, the analysis result may include a phonation percentage/ratio, a sound pressure level, a pitch of voice and a distribution of speech and nonspeech.

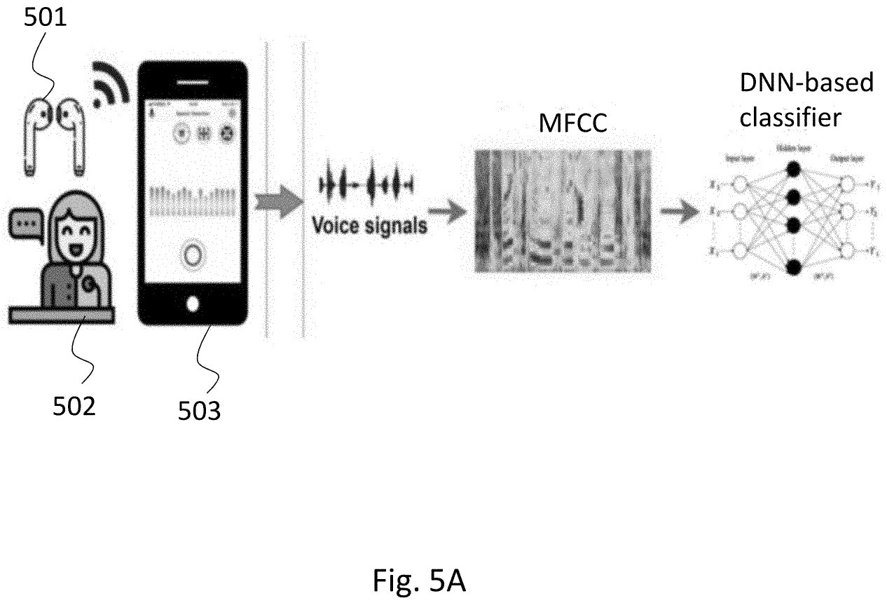

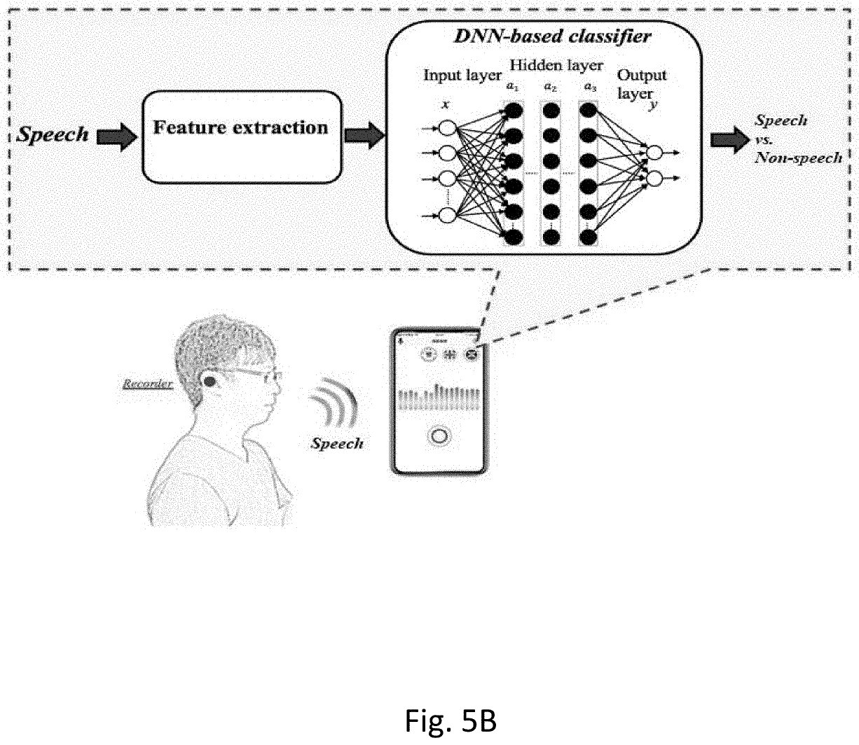

Reference is next made to FIG. 5, which illustrates a system used to monitor an individual's phonation according to a second embodiment of the present invention.

In the present embodiment, recorder 501 is implemented as a wireless headphone. The recorder 501 is configured to receive a voice signal from a tester 502. The recorder 501, in the present embodiment, communicates with the computing device 503 through Bluetooth®. However the communication is not limited to Bluetooth® only. Other wireless communication approaches can also be utilized.

The voice signal is then processed. The recorded voice samples were processed to capture the Mel-frequency cepstral coefficients (MFCCs), and the obtained MFCC features and the results of manual (or automatic) labeling (i.e., speech vs. non-speech) were used to train a DNN model.

In sum, the present invention provides (1) a wireless microphone to pick up voice signals of users and transfer to another mobile device via Bluetooth® or other technology; (2) a machine-learning algorithm to detect user's voice, discarding background noise and voice form other people; (3) real-time monitoring of voice use, including the percentage of phonation during a certain period of time, phonation volume (in decibel), and phonation pitch (Hz); and (4) real-time feedback when the phonation amount, volume, or pitch exceed the predefined threshold.

By the novel techniques of artificial intelligence to develop a system for real-time monitoring and feedback of occupational voice use as provided in the present invention, teachers and other occupational voice users can be benefited therefrom. In the present invention, a voice recorder (e.g., an AirPods®) is utilized to receive voice signals. The voice is then transmitted to a processing device (e.g., an iPhone®) via Bluetooth® coupling. An iOS app is also developed to capture personalized vocal features and perform deep neural networks to differentiate between user's voice and other sound source (e.g., noises or students' voices in a class). In the present invention, it is also demonstrated that the distribution of voicing segments, phonation percentage, volume, and fundamental frequency, are all compatible with existing literatures.

A training process may be done by using the present invention, beginning with recording of a few speech sentences (e.g., 2-3 minutes) by subjects (e.g., the teachers) reading a standard passage. Subsequently, the recorded voice sample was manually (or automatica) labeled as speech or non-speech.

Next, the recorded voice samples were processed to capture the Mel-frequency cepstral coefficients (MFCCs), as previously described. The obtained MFCC features and the results of manual labeling (i.e., speech vs. non-speech) were used to train a DNN model, which consists, in the present invention for example, of 3 hidden layers, with 150 neurons in each layer. The layers and neurons as used in the present invention is only for exemplary purpose, therefore the scope of the present invention should not be limited by the specific layers and neurons.

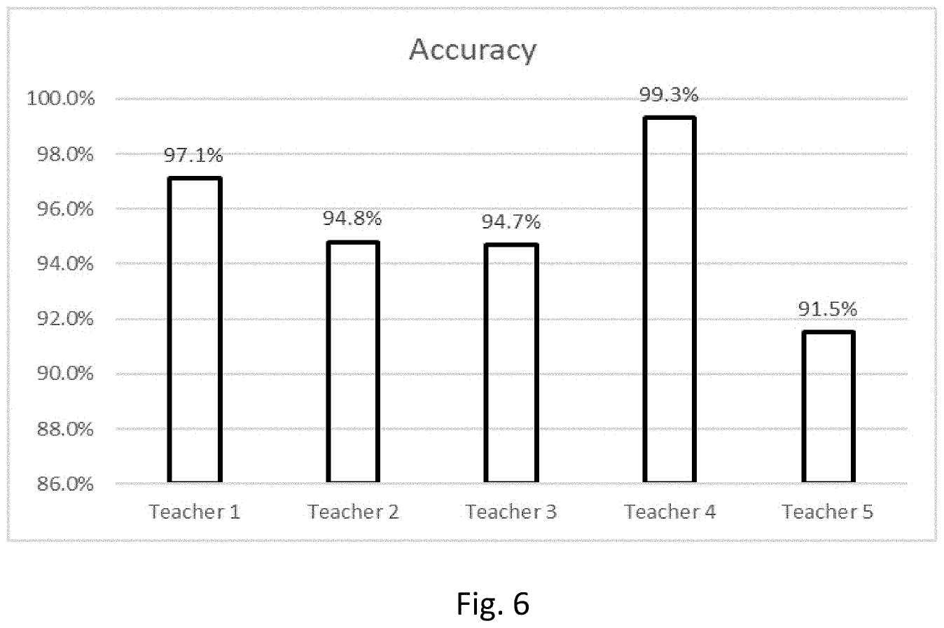

An experiment with five testers (e.g., teachers) involved to verify the performance of the present invention. The testers are asked to read a standard passage, which is later used to train the individualized DNN recognition model. The individualized DNN model of the present invention achieved accuracy higher than 90% (frame-based, frame width 64 ms), and the model was implanted in an iOS application for example. The accuracy rate of the five teachers can be referenced in FIG. 6, which illustrates the experimental results of the accuracy rate of the personal phonation recognition module among five teachers.

Teachers, an occupation taken for an example, are benefited by the present invention. Such occupation is one of the most common occupation to suffer from voice disorders, because of their extreme high vocal demands. Although traditional voice therapies provide good treatment effectiveness, traditional voice therapies cannot monitor patients regarding their phonation speed and volume, and whether they take adequate rest during daily use Controlling phonation speed and volume is a key component for successfully management of voice disorders.

This application is specifically designed to accomplish the following tasks: (1) real-time processing of voice signals into MFCC features, and (2) real-time recognition of acoustic signals as speech or non-speech using the individualized DNN model. The testers are instructed on how to use AirPods 2, iPhone 8 plus, and the mobile app during a regular teaching class of 40-50 minutes. None of the five subjects reported discomfort or inconvenience while using the present invention.

Recorded data are then processed to calculate the phonation ratio (frames of speech/total frames) every min. The phonation ratio ranged from 50% to 80% per min for these five teachers. The phonation volume (mode of approximately 85 dB) and fundamental frequency (mode of approximately 120 Hz in men and 200 Hz in women) are demonstrated comparable results with previous reports.

Because the DNN model recognized speech (or non-speech) signals based on each frame of acoustic recording, which is so sensitive, that even short breaks between words during continuous speech would be detected. Accordingly, the duration of speech segments (on a logarithmic scale) ranged from 0.032 s to 3.16 s, which was shorter comparing to conventional technologies.

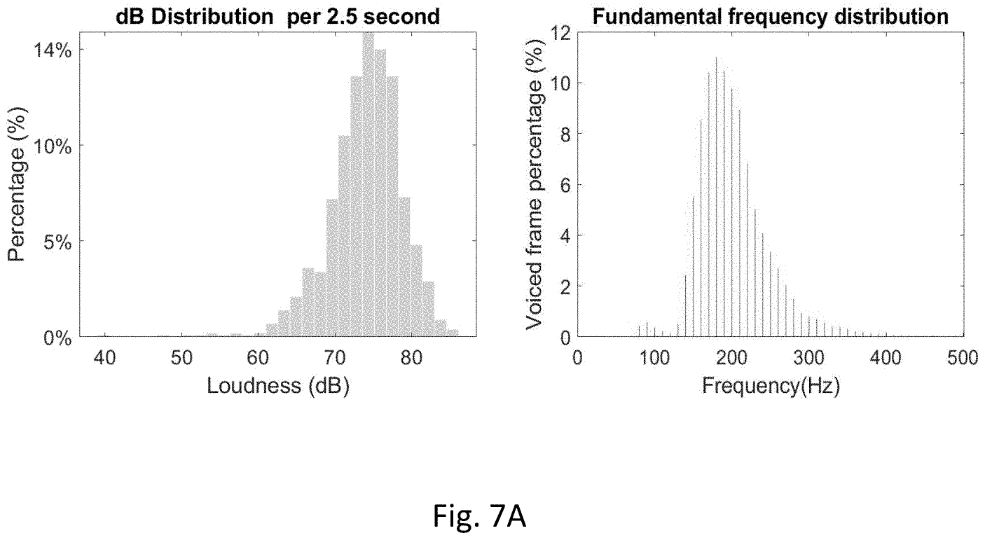

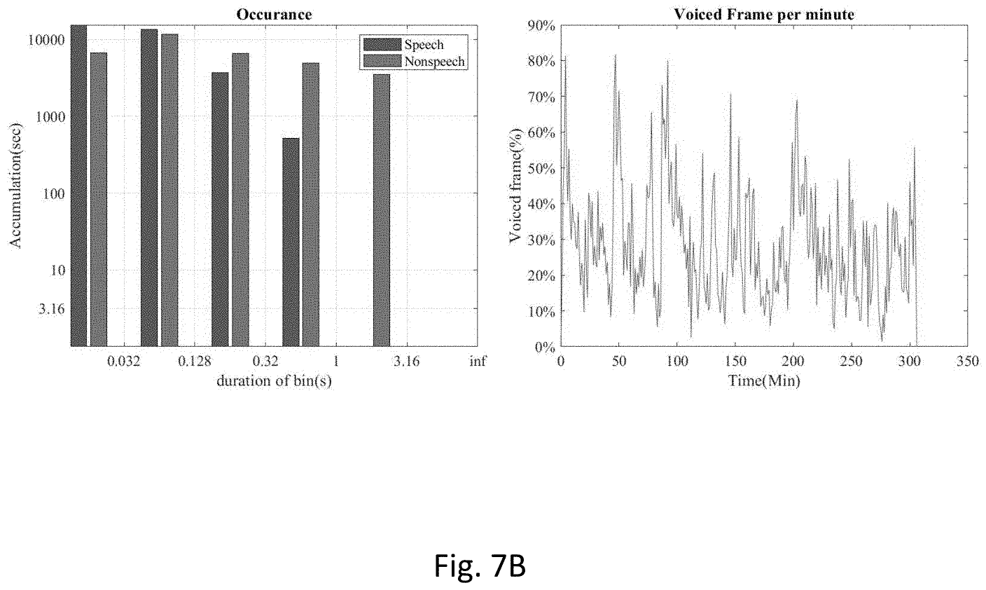

Reference is collectively made to FIGS. 7A-7B, which illustrates the analysis results of a first tester, with the analysis results including the distribution of speech vs non-speech, the phonation percentage/ratio (per minute), the sound pressure level, and the fundamental frequency (pitch).

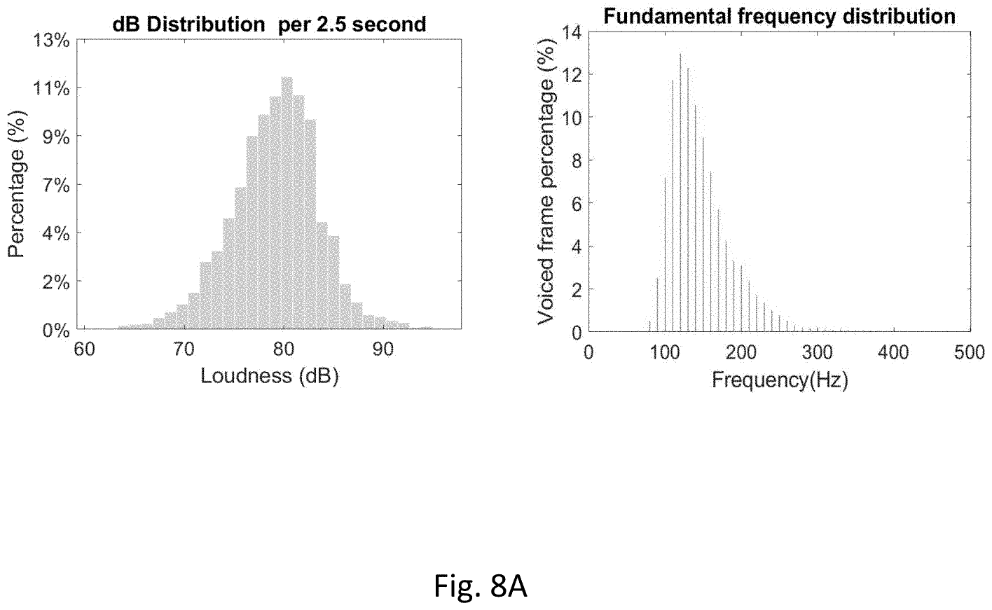

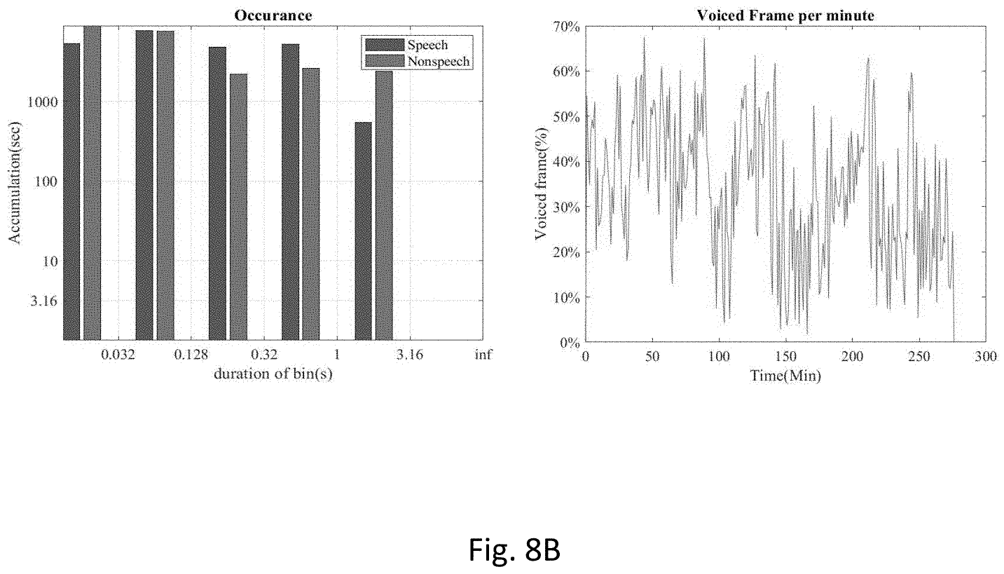

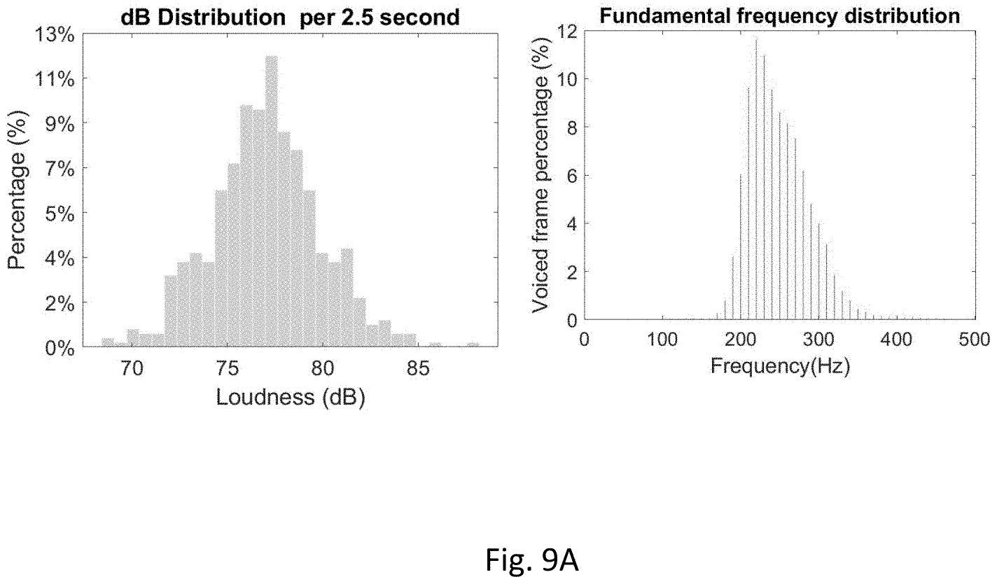

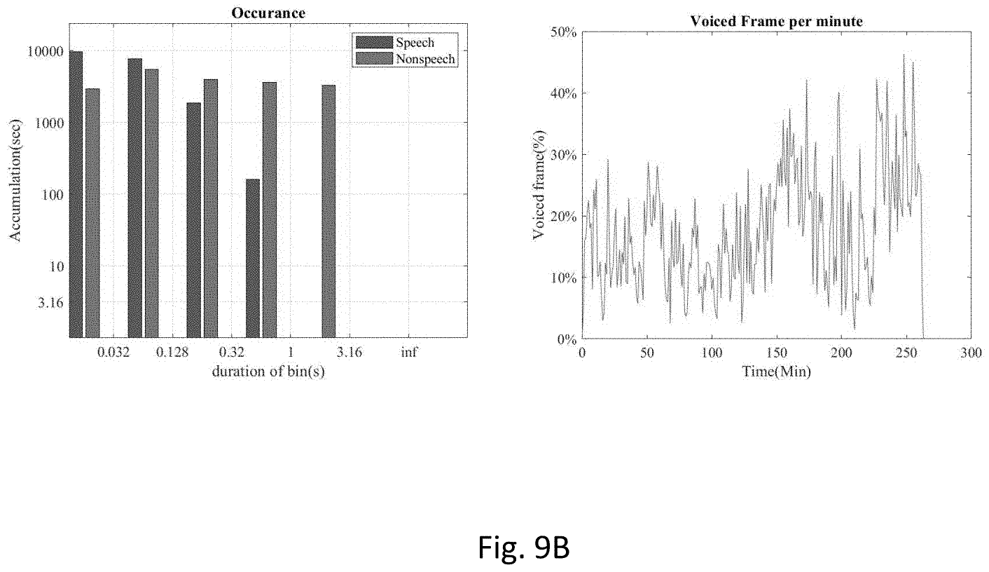

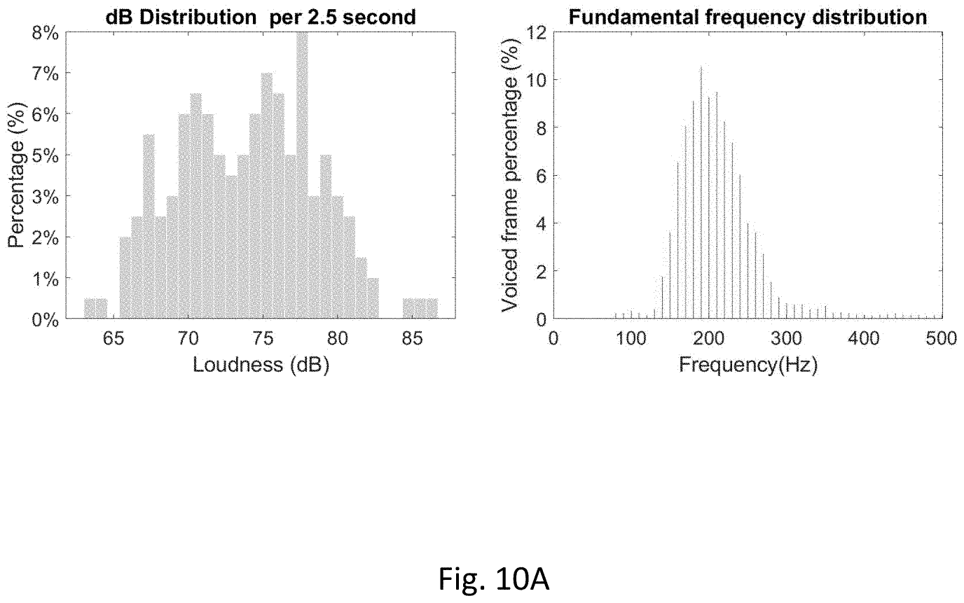

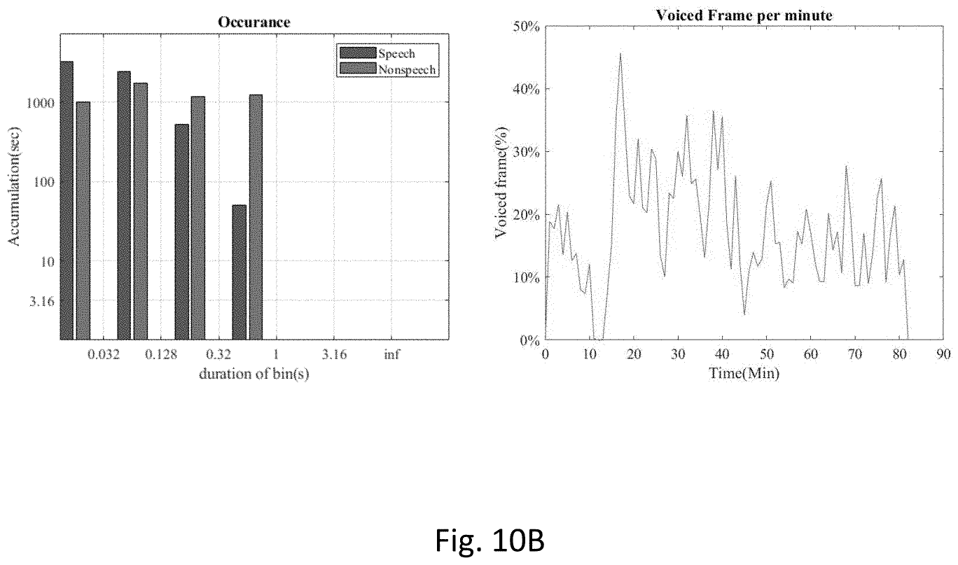

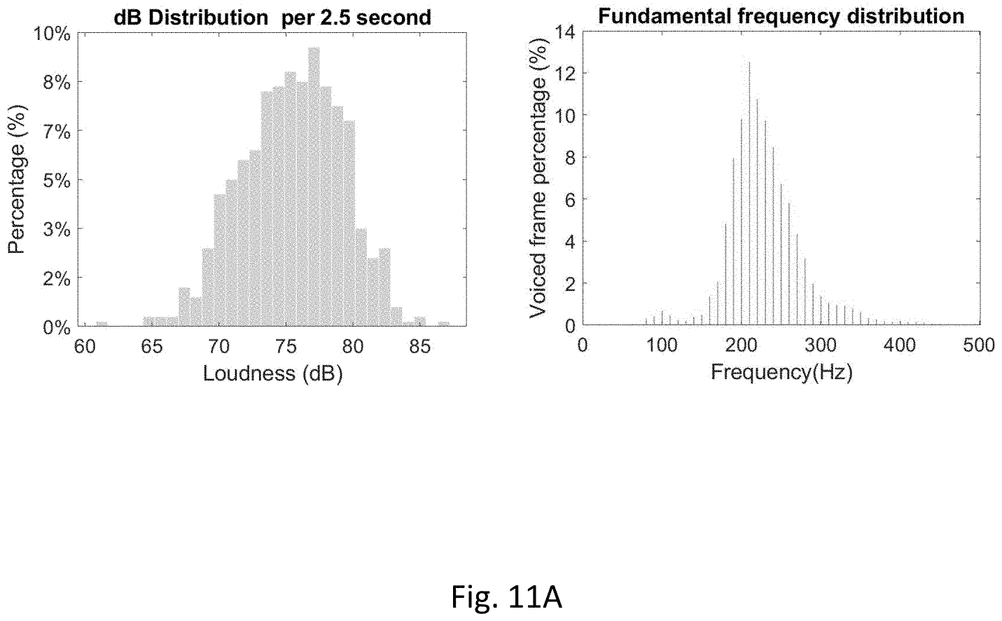

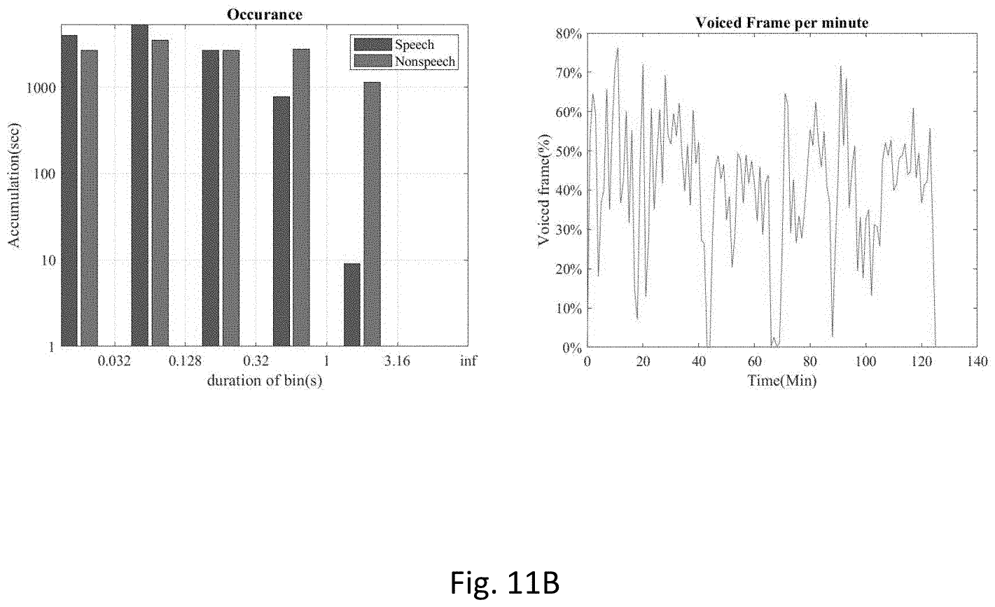

Similarly, FIGS. 8A-8B illustrates the analysis results of a second tester, FIGS. 9A-9B illustrates the analysis results of a third tester, FIGS. 10A-10B illustrates the analysis results of a fourth tester, and FIGS. 11A-11B illustrates the analysis results of a fifth tester. The analysis results for the second to fifth testers also include the distribution of speech vs non-speech, the phonation percentage/ratio (per minute), the sound pressure level, and the fundamental frequency (pitch).

In conclusion, the present invention successfully overcomes the disadvantages of existing device and conventionally-designed systems, which use neck-mounted microphone, contact microphone or accelerometer. The present invention shows that it can effectively and accurately detects the speech of the user and differentiates it from background noise or the voice of other speakers. The system of the present invention can also provide reliable data regarding the phonation ratio, speaking frequency and volume.

In sum, the present invention develops an integrated system which includes: (1) a wireless microphone to pick up voice signals of the users and transfer to another mobile device via Bluetooth or other technology; (2) a machine-learning algorithm to detect user's voice, in which background noise and voice form other people are filtered out; (3) real-time monitoring of voice use, including the percentage of phonation during a certain period of time, phonation volume (in decibel), and phonation pitch (Hz); and 4) real-time feedback when the phonation amount, volume, or pitch exceed the predefined threshold.

The present invention bring significant advancement to the relevant field, and helps to improve care taking toward dysphonic patients and occupational vocal users.

The wireless microphone as utilized in the present invention and real-time calculating voice features increases the acceptability of the system for users. By the disclosure, doctors and speech pathologists can order prescription of phonation modification through the system, for example, limit voice use to a certain level (e.g. 60% during a teaching class), avoid louder volume (e.g. no more than 85 decibels), or avoid high pitch (e.g. higher than 400 Hz), etc. After setting up these parameters of the proposed system, patients can bring this device to work and use it in their daily lives. When voice misuse or abuse is detected, the patients will receive an alarm (e.g., flash, vibration or sound) or a summary of voice usage condition during a certain period of time (e.g. each class), which can facilitate further correction of phonation habits.

In sum, a novel method and system, in which wireless microphone for receiving voice signals is applied, is provided by the present invention. The voice signals are then transmitted to a mobile device via Bluetooth® (or other wireless) technology. A mobile app may be applied to capture personalized vocal features. Meanwhile, the deep neural network approach as described is used to determine whether the input sound source is the user's voice or not in the frame level. The present invention demonstrates that the distribution of voicing segments, phonation percentage, volume and fundamental frequency are all compatible with existing literature.

In sum, the present invention brings significant advancements, and helps to improve treatments toward dysphonic patients and occupational vocal users. Wireless microphone and real-time calculating voice features will significantly increase the acceptability of the present invention for users. Doctors, accordingly, can order prescription of phonation modification through the present invention. For example, limiting voice use to a certain level (e.g. 60% during a teaching class), avoiding louder volume (e.g. no more than 85 decibels), or avoiding high pitch (e.g. higher than 400 Hz), etc.

Patients can use the system/device of the present invention to work and use it in their daily lives. When voice misuse or abuse is detected, the patients will receive an alarm (e.g., flash, vibration or sound as described above), which can facilitate further correction of phonation habits.

Unless otherwise defined, all terms (including technical and scientific terms) used herein have the same meaning as commonly understood by one of ordinary skill in the art to which this disclosure belongs. It will be further understood that terms; such as those defined in commonly used dictionaries, should be interpreted as having a meaning that is consistent with their meaning in the context of the relevant art and the present disclosure, and will not be interpreted in an idealized or overly formal sense unless expressly so defined herein.

1. A method to generate a phonation monitoring module, comprising:
collecting, by a recorder, a voice from an individual;
converting, by a processor, the voice to a voice signal;
extracting a signal feature from the voice signal;
providing a trained speech recognition neural network;
generating, by applying the signal feature to the trained speech recognition neural network, a voice marker; and
generating a personal phonation recognition module including the voice marker.

2. The method of claim 1, wherein in the step of extracting a signal feature from the voice signal, the signal feature is extracted by applying Mel frequency cestrum coefficients (MFCCs).

3. The method of claim 1, wherein the trained speech recognition neural network is provided through a decision tree procedure, a random forest procedure, an Adaboost procedure, a K Nearest-neighbor procedure, a Support Vector Machine (SVM) procedure, a Gaussian Mixture Model (GMM), a Deep Neural Network (DNN) procedure, a convolution neural network (CNN) procedure, a recurrent neural network (RNN) procedure.

4. The method of claim 1, wherein the personal phonation recognition module is stored on a portable device, a smart home/speaker device, a hearing assistive device or a cloud.

5. A method for monitoring phonation, comprising:
recording, by a recorder, a voice from an individual;
analyzing, by comparing the voice with the personal phonation recognition module of claim 1, to generate an analysis result; and
comparing the analysis result with a pre-set value,
wherein a feedback signal is given when the analysis result is higher or lower than the pre-set value.

6. The method of claim 5, wherein the feedback signal comprises a light, a sound, a vibration, a temperature variation, a letter notice, a figure notice and any combination thereof.

7. The method of claim 5, wherein the recorder is a portable recorder, smart home/speaker device, hearing assistive device, or a wireless headphone.

8. The method of claim 5, wherein the individual has a disease including phonotraumatic lesions and hyperfunctional voice disorders.

9. The method of claim 5, wherein the analysis result comprises: a phonation percentage, a sound pressure level, a pitch of voice and a distribution of speech and nonspeech.

10. A system to generate a phonation monitoring module, comprising:
a recorder;
a memory to store executable instructions; and
a processor, coupled to the memory, that facilitates execution of the executable instructions to perform operations, comprising:
collecting a voice from an individual;
converting the voice to a voice signal;
extracting a signal feature from the voice signal;
providing a trained speech recognition neural network;
generating a voice marker by applying the signal feature to the trained speech recognition neural network; and
generating a personal phonation recognition module including the voice marker.

11. The system of claim 10, wherein the signal feature is extracted by applying Mel frequency cestrum coefficients (MFCCs).

12. The method of claim 10, wherein the trained speech recognition neural network is provided through a decision tree procedure, a random forest procedure, an Adaboost procedure, a K Nearest-neighbor procedure, a Support Vector Machine (SVM) procedure, a Gaussian Mixture Model (GMM), a Deep Neural Network (DNN) procedure, a convolution neural network (CNN) procedure, a recurrent neural network (RNN) procedure.

13. The method of claim 10, wherein the personal phonation recognition module is stored on a portable device, a smart home/speaker device, a hearing assistive device or a cloud.

14. A system used to monitor an individual's phonation, comprising:
a recorder; and
a computing device, comprising:
a memory to store executable instructions; and
a processor, coupled to the memory, that facilitates execution of the executable instructions to perform operations, comprising:
recording a voice from an individual;
analyzing, by comparing the voice with the personal phonation recognition module of claim 1, the voice; and
comparing the analysis result with a pre-set value, wherein a feedback signal is given when the analysis result is higher or lower than the pre-set value,
wherein the recorder connects with the computing device.

15. The system of claim 14, wherein the feedback signal comprises a light, a sound, a vibration, a temperature variation, a letter notice, a figure notice and any combination thereof.

16. The system of claim 14, wherein the recorder is a portable recorder, smart home/speaker, hearing assistive device, or a wireless headphone.

17. The system of claim 14, wherein the individual has a disease including phonotraumatic lesions and hyperfunctional voice disorders.

18. The system of claim 14, wherein the analysis result comprises: a phonation percentage/ratio, a sound pressure level, a pitch of voice and a distribution of speech and nonspeech.
